(19) United States
(12) Patent Application Publication
(10) Pub. No.: US 2012/0221196 A1
(43) Pub. Date: Aug. 30, 2012

(54) ACTIVE TIRE CONTROLLER DEVICE

(75) Inventors: Shafer Seymour, Bartlett, IL (US); David Pivonka, Winfield, IL (US)

(73) Assignee: CONTINENTAL AUTOMOTIVE SYSTEMS, INC., Deer Park, IL (US)

(21) Appl. No.: 13/036,129

(22) Filed: Feb. 28, 2011

(51) Int. Cl. G06F 7/00

(52) U.S. Cl. 701/36

(57) ABSTRACT

A control system and method for enhancing motor vehicle fuel economy. The system and method establishes a vehicle operating in either a city operating condition or highway operating condition. Once a highway operating condition is established, an on-board motor vehicle tire pressure pneumatic controller may be commanded set a relatively higher tire inflation pressure optimizing the tires for minimizing rolling resistance and thereby enhancing fuel economy. In a city operating condition, tire inflation pressure may be returned to nominal values optimizing inflation pressure for vehicle dynamic capabilities for maneuvering, braking, or traction. Distinguishing between the operating conditions may be based on one or more of a number of parameters of the motor vehicle.

### FIELD OF THE INVENTION

This invention relates to motor vehicle systems and particularly to a controller device and system for the active control of tire attributes in motor vehicles.

### BACKGROUND

Designers of motor vehicles such as passenger cars, and light and heavy trucks are constantly striving to improve the performance capabilities of these vehicles. One particularly important area of current design effort is reducing the fuel consumption of the vehicles, or stated in another way, improving fuel economy. Numerous characteristics and systems on board of a motor vehicle affect its fuel economy. The vehicle's tires play a major role in the dynamic stability of a vehicle, traction, ride and handling, comfort, and significantly, fuel economy. Manufacturers of motor vehicle tires have devoted much attention to reducing their rolling resistance while maintaining other characteristics of tire performance. Tire rolling resistance is affected by numerous factors including tire aspect ratio, tire structural characteristics, as well as the tire tread patterns and tire body compositions. One significant parameter of tire performance for pneumatic tires is their inflation pressure. The characteristics of the tire can change significantly over a range of inflation pressures. Most motor vehicles do not have a system for adjusting their tire inflation pressure in an active manner during vehicle operation. For those vehicles, the operator is advised to inflate tires within a particular range recommended by the vehicle and tire manufacturer, which provides a good trade-off among the various tire performance parameters. It is known that increasing inflation pressure can reduce vehicle rolling resistance by decreasing sidewall deflection and reducing the area of the tire contact patch with the road. Higher tire inflation pressure, optimizing for fuel economy, however, has a tradeoff in terms of other tire performance characteristics.

Active tire inflation pressure systems are available for some motor vehicles types including commercial vehicles and certain specialty truck and passenger car vehicles. Active tire pressure control allows lost inflation pressure to be made up actively during operation of the vehicle. In certain special use applications such as off-road and military vehicles, active tire pressure control systems allow reductions in tire pressure for off-road applications for example allowing the pressure to be returned to normal road operating conditions when desired.

### SUMMARY

A motor vehicle having an active tire pressure control system incorporates a controller which uses external input information to control tire pressure in a manner intended to optimize fuel economy in certain vehicle operating conditions. For example, in highway operating conditions operating at a constant speed, tire pressure may be increased actively to reduce vehicle rolling resistance and thereby enhance fuel economy. The system of this invention, through use of the various vehicle operating parameters, can reduce tire pressure from optimization for fuel economy to provide desired vehicle dynamic characteristics when such characteristics are likely to be necessary such as city operating conditions where maneuvering, cornering, and crowded traffic or on city streets or other operating conditions is likely.

This invention includes the described embodiments of systems and methods achieving the above-referenced characteristics, which are explained in more detail in this specification and drawings.

### BRIEF DESCRIPTION OF THE DRAWINGS

Example embodiments of the invention are reflected in the drawings and will be described below. The drawings show:

FIG. 1 is a perspective view of a representative motor vehicle incorporating the features of the present invention;

FIG. 2 is a schematic diagram of a tire pressure control system in accordance with the present invention;

FIG. 3 is a process step diagram of a method in accordance with the present invention.

### DETAILED DESCRIPTION

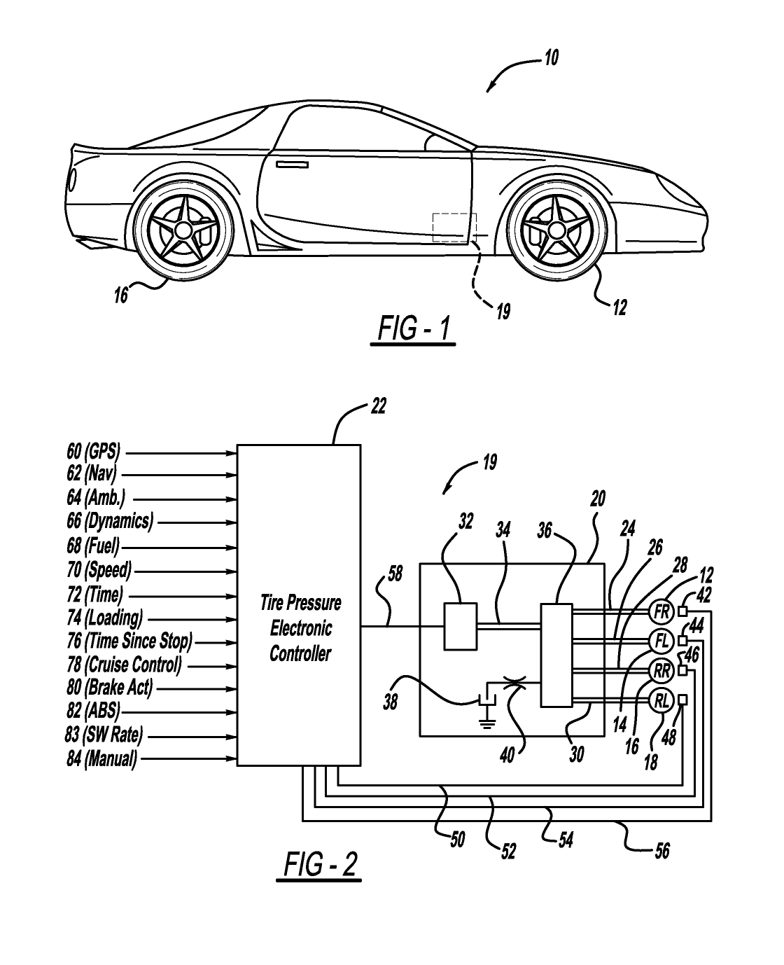

A representative motor vehicle 10 is shown in FIG. 1 which includes a tire pressure control system 19. The motor vehicle 10 includes set of four road engaging tires, including front right tire 12, front left tire 14, rear right tire 16, and rear left tire 18, as shown in FIG. 2. Motor vehicle 10 incorporates tire pressure pneumatic controller 20, which is connected via inflation lines 24, 26, 28, and 30 to respective tires 12 through 18. Tire pressure electronic controller 22 provides control signals which operate the pneumatic controller 20 to provide desired tire pressure as is described in further detail as follows.

As illustrated in FIG. 2, the system is divided mainly into two primary sub-elements, namely, electronic controller 22 and pneumatic controller 20. Tire pressure pneumatic controller 20 provides a means for controlling the flow of inflation air into and out of individual tires 12-18. Active tire pressure control systems incorporate some means of communicating inflation lines 24-30 to the rotating tires which can be done through wheel bearings or other means. These systems operate by the air pressure maintained in the line being communicated to the tire while the vehicle is operating.

It should be noted that other means of active tire pressure control may incorporate the features of this invention which do not incorporate a direct pneumatic line connection with each of the tires. For example, it can be envisioned that a pump mechanism rotating with the tire could communicate with ambient air and further incorporate an exhaust valve which components rotate with the tire and communicate to an electronic controller wirelessly, for example through an RF interface. The precise means for providing inflation air and exhausting air to atmosphere for adjusting tire inflation pressure is, however, outside the scope of the present invention. Pneumatic controller 20 is described as one representative mechanism for actively controlling tire inflation pressure in individual tires.

Tire pressure pneumatic controller 20 includes a mechanical inflation pump 32 which can be powered by the vehicle's electric bus and can provide air pressure on output line 34 to valve 36. Shuttle valve 36 communicates individually to inflation lines 24-30. Similarly, shuttle valve 36 also communicates with a vent 38 which exhausts inflation air to the atmosphere and may likely include a flow restrictor 40 for controllably releasing inflation air to the atmosphere. Shuttle valve 36 can be mechanically or electrically actuated to individually connect pump output line 34 or vent line 38 to individual tires 12-18 through their respective inflation lines 24-30 to individually control the tire inflation pressure of each road engaging wheel.

Some mechanism for monitoring pressure inside each tire 12-18 would be preferably included. This could comprise simply measuring pressure in each of the inflation lines 24-30, or using an in-tire or on-tire rotating tire pressure sensor as it is in common use in presently available tire pressure monitoring systems. Through either approach, whether through fixedly mounted sensors in the inflation lines 24-30 or through inflation sensors 42, 44, 46 and 48, an inflation pressure signal for each of tires 12-18 is fed on signal lines 50, 52, 54 and 56 to tire pressure electronic controller 22. Thus, through this representative system, tire pressure electronic controller 22 receives inputs related to the pressure of each road-engaging tire 12-18 in a real time manner.

Tire pressure electronic controller is a microprocessor-based, on-board electronic controller system having logic means, which may be either its own modular unit or incorporated into other vehicle electronic packages. Through processing one or a plurality of inputs described in more detail as follows, tire pressure electronic controller 22 outputs a control signal on line 58 to pneumatic controller 20, providing instructions for the setting of tire inflation pressure in each of the tires 12-18.

Tire pressure electronic controller 22 receives one or a number of inputs related to a vehicle operating parameter which is in turn related to desired tire pressure conditions, which may be used specifically to enhance fuel economy for motor vehicle 10 while providing desired vehicle dynamic characteristics based on tire pressure where such characteristics are needed.

Tire pressure control system 19 is based on the principle that by monitoring the vehicle operating parameters that enable anticipation of operating conditions of the vehicle, or by evaluating a history of operating parameters for a vehicle, enhanced tire pressure adjustment can be provided. For example, if a driver is operating his/her vehicle on a highway over a long-distance trip where the vehicle is expected to be operated at a relatively high speed over a long period of time, termed here as a “highway operating condition”, tire pressure can be increased, since in such operating conditions, requirements for tire dynamic maneuvering are reduced. If, however, the driver exits a freeway for a stop within a city or where other maneuvering is required, termed here as a “city operating condition”, tire pressure can be optimized for returning the vehicle to its normal dynamic control characteristics by reducing tire pressure. Accordingly, while operating in the highway operating condition, the vehicle is afforded lower tire rolling resistance through higher inflation pressure thus contributing to increased fuel economy. Numerous operating parameter inputs can be processed by electronic controller 22 to provide the features of this invention. Examples of such inputs are described in the following paragraphs.

FIG. 2 illustrates a number of operating parameters which may be applied to tire pressure electronic controller 22. Each of these operating parameters may be related to the motor vehicle 10 being operated in one of at least two different operating conditions, namely the highway operating condition and the city operating condition.

In a highway operating condition, the vehicle is operating at a relatively high rate of speed (e.g., exceeding 60 mph), for example, on a limited access freeway, toll way, or highway. The highway operating condition is characterized by long periods of driving in a relatively straight ahead manner with a minimal requirement for maneuvering the vehicle or stopping for intersections, obstacles, or for other reasons.

The city operating condition is characterized by the need to maneuver the vehicle, for example, start and stop driving in city traffic, cornering maneuvers, parking, and other vehicle operating characteristics associated with driving a vehicle in a city.

For the highway operating condition, tire inflation pressure of tires 12-18 can be optimized for reducing rolling resistance, thereby enhancing fuel economy. For example, in commonly used passenger car motor vehicles, the tire pressure could be set at a relatively high value (e.g., 35-40 psi). While there is a tradeoff between optimization for rolling resistance and vehicle dynamic characteristics, the highway operating condition favors optimization for rolling resistance for enhanced fuel economy. In the city operating condition, the tire inflation pressures can be lowered to a nominal value (e.g. 30-35 psi) which optimizes the tires for vehicle dynamic handling characteristics. These optimized dynamic handling characteristics enhance braking, vehicle maneuvering, and needed traction.

FIG. 2 illustrates a number of the specific operating parameters which may be inputted and processed by electronic controller 22. In a representative system, any one of the inputs related to an operating parameter may be processed by electronic controller 22 or, alternatively, a plurality of such inputs may be implemented.

GPS operating parameter 60 is related to a GPS receiver within the vehicle 10, providing a GPS-derived signal based on changing vehicle position. Thus, the GPS signal 60 can be used to generate signals related to vehicle speed, steering maneuvers, or other GPS-based parameters which enable a selection between the city and highway operating conditions.

Navigation operating parameter 62 may be associated with an on-board vehicle navigation system having an internally stored electronic map. The vehicle's position (as established by a GPS input 60) is used to place the vehicle 10 on a map. The map can indicate the type of road surface the vehicle is being operated on, or the posted speed limit for the road which aids in distinguishing between the city and highway operating conditions. Moreover, an inputted navigation route may be processed to establish anticipated vehicle road conditions distinguishing between the operating conditions.

Ambient condition operating parameter 64 may be related to existing weather or atmospheric conditions such as precipitation, temperature, humidity, or other factors. These inputs can be used to maintain optimized vehicle traction characteristics and thus establish the city operating condition when ambient conditions indicate a wet road surface or one having snow or ice. For certain ambient conditions, such as those just mentioned, it would be undesirable to set an inflation pressure optimized for reduced rolling resistance.

Dynamics parameter 66 may be derived from an electronic on-board system controlling the vehicle's dynamic behavior and performing functions, such as anti-lock braking, traction control, or automatic yaw control (including dynamic stability control and rollover stability control). Dynamics parameter 66 serves to establish the city operating condition when the vehicle is being maneuvered, for example in an accident avoidance condition or where the dynamics input indicates the vehicle has been operated in a city driving condition.

Fuel level parameter 68 can be used to establish a city operating condition when the on-board fuel level is low, indicating that the vehicle operator will need to bring the vehicle to a stop for refueling.

Vehicle speed parameter 70 may be derived from numerous sources including wheel speed sensors, inertia sensors, GPS signals, or other inputs related to vehicle speed. High vehicle speeds would indicate a highway driving condition whereas low indicated speeds would be associated with a city driving condition. For example, a speed threshold of 60 mph could be established as a means of distinguishing between city and highway operating conditions.

Time-of-day parameter 72 may be used to maintain normal tire inflation pressure associated with a city driving condition in nighttime for example.

Vehicle loading parameter 74 can be used to establish the city operating condition for tire inflation when the vehicle is heavily loaded where the dynamic performance of the vehicle may be near design limits and where it would be undesirable to optimize the tire inflation pressure for minimizing rolling resistance.

Time-since-stop parameter 76 may be a timer which enables a prediction of the need for a vehicle stop for resting a driver or for refueling. The controller 22 would establish the city operating condition in such situations.

Cruise control operating parameter 78 can be related to an operator setting the vehicle's cruise control (which could be an adaptive type), indicating operation in a highway operating condition.

Brake actuation operating parameter 80 enables the system to establish a city operating condition when vehicle brakes are being applied by the operator, or when there is a recent history of brake applications indicating the city operating condition.

ABS control operating parameter 82 is an output of an on-board anti-lock brake system (ABS) to provide inputs to electric controller 22. The ABS signal can be related to a detection of relative wheel slip between four wheels. A related input would be based on a traction control system (TCS) which again enables the vehicle on-board systems to identify wheel traction operating conditions.

Manual vehicle input 84 may be a driver input switch or other signal in which the motor vehicle operator manually inputs a signal to electronic controller 22 when he or she anticipates the vehicle operating either in a city or highway operating condition. A manual input indicating highway operating condition can be overridden when any one or more of the previously mentioned inputs related to specific operating conditions indicate that the vehicle tire inflation pressure should be reset to the city driving condition. The system selects the city operating condition as the “default” condition since it represents a balance of all tire performance characteristics, with the highway operating condition selected only when conditions are suited for such operation. Further, the steering-wheel-rate parameter 83 may establish the driving condition based upon the rate of change or magnitude of steering wheel angle. It is also understood that the driving condition may be established by any combination of the above parameters.

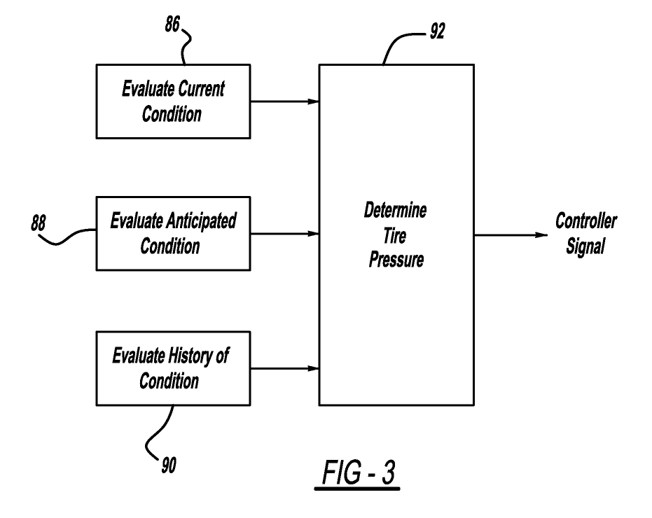

FIG. 3 indicates a process flow diagram for tire pressure control system 19. Step 86 indicates that the system evaluates current operating conditions. This can be achieved by processing data related to any of the previously mentioned operating parameter inputs 60 through 83, and manual input 84. Process step 88 involves an evaluation of anticipated operating conditions, which is again potentially related to operating parameter inputs 60 through 83. For example, inputs from a navigation operating parameter 62, fuel level 68, time of day 72, vehicle loading 74, and time since stop 76 can be used to anticipate operating conditions in the future. Process block 92 involves an evaluation of the history of operating conditions, which is again based on one or more of operating parameter inputs 60 through 82. Process block 92 is the step of determining tire inflation pressure setting as being associated with either the city operating condition or the highway operating condition. This decision may be based on one or more of current operating conditions 86, anticipating operating conditions 88, or the history of operating conditions 90. A controller signal on line 58 in FIG. 2 is then fed to pneumatic controller 20 which then establishes desired inflation pressure of each of tires 12 through 18. As previously mentioned, setting of these tire inflation pressures can be based on an open-inflation or closed-loop system in which feedback signals are provided for setting tire pressure.

The implementation of the control system and methods in accordance with the present invention is possible to enhance motor vehicle fuel economy by optimizing tire inflation pressure based on operating conditions (past, current, or anticipated). In addition, it is understood that other attributes of the tires may be modified by similar hardware and based on a similar decision process. For example, a tire may have multiple inflation zones including one for extending studs for ice driving, one for reduced rolling resistance at high speeds, one for improving wet-road performance and each inflation zone may be controlled as described above. Further, the various tire attributes may be controlled by techniques other than inflation for example by an electrical or mechanical movement.

While the above description constitutes the preferred embodiment of the present invention, it will be appreciated that the invention is susceptible to modification, variation, and change without departing from the proper scope and fair meaning of the accompanying claims.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of the invention. This description is not intended to limit the scope or application of the invention in that the invention is susceptible to modification, variation and change, without departing from spirit of the invention, as defined in the following claims.

1. A tire pressure control system for a motor vehicle having road-engaging tires and an active tire pressure control system enabling the inflation pressure of the tires to be adjusted while the motor vehicle is in motion, comprising:
a tire pressure pneumatic controller for adjusting the inflation pressure of at least one of the tires based upon a control signal,
a tire pressure electronic controller for generating the control signal,
at least one input applied to the electronic controller based on an operating parameter of the vehicle applied to the electronic controller, and
the electronic controller having logic means for processing the input and generating the output in a manner setting the tire inflation level to a value optimizing the inflation pressure for reduced rolling resistance when the operating parameter is related to the vehicle being operated in a highway operating condition, and setting the tire inflation level to a reduced value optimizing the inflation pressure for vehicle dynamic capabilities when the operating parameter is related to the vehicle being operated in a city driving condition.

2. A tire pressure control system in accordance with claim 1, wherein the operating parameter is related to one or more of the following; a navigation system parameter, a GPS condition parameter, a vehicle dynamics parameter, a fuel level parameter, a vehicle speed parameter, a time of day parameter, a vehicle loading parameter, a time-since-last-stop of vehicle parameter, a cruise control setting parameter, a brake actuation parameter, a steering wheel rate parameter, and a manual operator input.

3. A tire pressure control system in accordance with claim 2, wherein the navigation system parameter resolves between the driving conditions based on the position of the vehicle on a map and based on the road surface type or posted speed as indicated by the map.

4. A tire pressure control system in accordance with claim 2, wherein the GPS condition parameter resolves between the driving conditions as indicated by a GPS-derived signal based on changing vehicle position.

5. A tire pressure control system in accordance with claim 2, wherein the vehicle dynamics parameter resolves between the driving conditions based on the current or past dynamic maneuvering of the vehicle.

6. A tire pressure control system in accordance with claim 2, wherein the fuel-level parameter establishes the city operating condition when the fuel level is low indicating that the vehicle will require a stop.

7. A tire pressure control system in accordance with claim 2, wherein the vehicle speed parameter resolves between the driving conditions based on the vehicle speed being above or below a speed threshold.

8. A tire pressure control system in accordance with claim 2, wherein the time-of-day parameter resolves among the driving conditions based on the time of day.

9. A tire pressure control system in accordance with claim 2, wherein the vehicle loading parameter establishes the city driving condition when the vehicle is heavily loaded.

10. A tire pressure control system in accordance with claim 2, wherein the time-since-last-stop parameter establishes the city driving condition when the time of operation of the vehicle indicates an anticipated need to stop the vehicle.

11. A tire pressure control system in accordance with claim 2, wherein the cruise control parameter resolves between the driving conditions based on use or non-use of a cruise control system of the vehicle.

12. A tire pressure control system in accordance with claim 2, wherein the brake actuation parameter establishes the city operating condition when the brakes of the vehicle are actuated.

13. A tire pressure control system in accordance with claim 2, wherein the steering-wheel-rate parameter establishes the driving condition based upon the rate of change or magnitude of steering wheel angle.

14. A tire pressure control system in accordance with claim 2, wherein the manual operator input resolves between the city operating condition and driving conditions based on a command by the vehicle operator.

15. A tire pressure control system in accordance with claim 14, wherein the manual operator input can be overidden by the controller based on one or more other of the parameters.

16. A tire pressure control system in accordance with claim 2, wherein the operating condition is related to at least two of the operating parameter inputs.

17. A tire pressure control system in accordance with claim 1, wherein the tire pressure control system enables the inflation pressure of a plurality of the tires to be controlled.

18. A method of adjusting tire pressure for a motor vehicle of a type having road engaging tires and an active tire pressure control system enabling the inflation pressure of the tires to be adjusted while the motor vehicle is in motion, comprising the steps of:
processing at least one operating parameter of the vehicle related to past, current or anticipated operating conditions and generating an output inputted to the active tire pressure control system,
setting the tire inflation level to optimizing the inflation pressure for reduced rolling resistance value when the operating parameter is related to the vehicle being operated in a highway operating condition, and setting the tire inflation level to a reduced value optimizing the inflation pressure for vehicle dynamic capabilities when the operating parameter is related to the vehicle being operated in a city driving condition.

19. A method in accordance with claim 18, wherein the operating parameter is related to one or more of the following; a navigation system parameter, a GPS parameter, a vehicle dynamics parameter, a fuel level parameter, a vehicle speed parameter, a time-of-day parameter, a vehicle loading parameter, a time-since-last-stop of vehicle parameter, a cruise control setting parameter, a brake actuation parameter, a steering wheel rate parameter, or a manual operator input.

20. A method in accordance with claim 19, wherein the navigation system parameter resolves among the conditions based on the position of the vehicle on a map and based on the road surface type or posted speed as indicated by the map.

21. A method in accordance with claim 19, wherein the GPS condition parameter is related to a GPS derived signal based on changing vehicle position.

22. A method in accordance with claim 19, wherein the vehicle dynamics parameter resolves among the conditions based on the current or past dynamic maneuvering of the vehicle.

23. In a computer readable storage medium having stored therein instructions executable by a programmed processor for adjusting tire pressure in a motor vehicle of a type having road engaging tires and an active tire pressure control system enabling the inflation pressure of the tires to be adjusted while the motor vehicle is in motion, the storage medium comprising instructions for:
processing at least one operating parameter of the vehicle related to past, current or anticipated operating conditions and generating an output inputted to the active tire pressure control system,
setting the tire inflation level to optimizing the inflation pressure for reduced rolling resistance value when the operating parameter is related to the vehicle being operated in a highway operating condition, and setting the tire inflation level to a reduced value optimizing the inflation pressure for vehicle dynamic capabilities when the operating parameter is related to the vehicle being operated in a city driving condition.

24. A tire attribute control system for a motor vehicle having road-engaging tires and an active tire attribute control system enabling attributes of the tires to be adjusted while the motor vehicle is in motion, comprising:
a tire attribute controller for adjusting of at least one of the tires based upon a control signal,
a tire attribute electronic controller for generating the control signal,
at least one input applied to the electronic controller based on an operating parameter of the vehicle applied to the electronic controller, and
the electronic controller having logic means for processing the input and generating the output in a manner setting a tire attribute level to a value optimizing the tire attribute for one of a plurality of driving conditions.

25. A tire pressure control system in accordance with claim 24, wherein the operating parameter is related to one or more of the following; a navigation system parameter, a GPS condition parameter, a vehicle dynamics parameter, a fuel level parameter, a vehicle speed parameter, a time of day parameter, a vehicle loading parameter, a time-since-last-stop of vehicle parameter, a cruise control setting parameter, a brake actuation parameter, a steering wheel rate parameter, and a manual operator input.
